(19) United States
(12) Patent Application Publication
(10) Pub. No.: US 2008/0256109 A1
(43) Pub. Date: Oct. 16, 2008

(54) Dynamic Podcast Content Delivery

(75) Inventors: William Irvin, Laguna Beach, CA (US); Chad E. Steelberg, Newport Beach, CA (US); Ryan S. Steelberg, Irvine, CA (US); Russell K. Ketchum, Newport Beach, CA (US); John B. Park, Irvine, CA (US); Matt Chalawsky, Los Angeles, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/735,387

(22) Filed: Apr. 13, 2007

(51) Int. Cl. G06F 17/00

(52) U.S. Cl. 707/102; 707/E17.101

(57) ABSTRACT

Systems and methods for delivering podcast content dynamically in an automated podcast platform. In general, one aspect can be a method that includes receiving a request to download a podcast, and determining an item of audio content to be inserted into the podcast. The method also includes inserting the item of audio content into the podcast dynamically at a predetermined time. Other implementations of this aspect include corresponding systems, apparatus, and computer program products.

### TECHNICAL FIELD

This disclosure generally relates to systems and methods for delivering podcast content dynamically in an automated podcast platform.

### BACKGROUND

Technology has made what is already a fast-paced world even faster and has created a mobile society where people prefer to receive media content in their own privacy and on their own time. Various broadcasters, such as individuals, corporations, and radio stations, have used podcasting as a medium to get their messages heard in today's mobile society. Similarly, podcasting has become a popular method for listeners to stay in touch with news and other broadcast media content. A podcast is a media file (e.g., in MP3 format) that is distributed over the Internet, for playback on portable media players (e.g., an Apple iPod) and personal computers. As podcasting becomes more popular, content broadcasters (for example, radio stations) require an automated system to easily repurpose existing content for podcasting.

### SUMMARY

This specification describes technologies relating to systems and methods for delivering podcast content dynamically in an automated podcast platform. In general, one aspect can be a method that includes receiving a request to download a podcast, and determining an item of audio content to be inserted into the podcast. The method also includes inserting the item of audio content into the podcast dynamically at a predetermined time. Other implementations of this aspect include corresponding systems, apparatus, and computer program products.

Another general aspect can be a system that includes a media asset inventory configured to store one or more broadcast audio files and an audio toolbox configured to manipulate the one or more broadcast audio files stored in the media asset inventory. The system also includes a podcast hosting server and means for dynamically delivering a targeted audio content to a listener. The system further includes a speech-to-text conversion engine configured to convert the one or more broadcast audio files into a text file.

These and other general aspects can optionally include one or more of the following specific aspects. The method can further include publishing the podcast at a hosting site and sending a Really Simple Syndication (RSS) feed to a podcast aggregator. The method can additionally include generating the podcast based on one or more broadcast audio files and obtaining the one or more broadcast audio files from a media asset inventory. The method can also include performing a speech to text conversion of the podcast, and obtaining a text version of the podcast. Further, the method can include generating one or more keywords based on the text version of the podcast.

The generation of the podcast can include obtaining podcast information through a first graphical user interface (GUI), and specifying a podcast publication time using a second GUI. The podcast information can include one or more of the following items: title, subtitle, artist, description, summary, keyword, and category. The predetermined time can be at podcast download time. The hosting site can be an FTP site maintained by a broadcaster, or part of an automated podcasting system. The item of audio content can be an advertisement or a voice track. The voice track can be a disc jockey announcement or a public service announcement.

Particular aspects can be implemented to realize one or more of the following advantages. A podcast hosting system can used to function as a backend tool (e.g., the “Google podcast backend”) in an automated podcast platform. As a hosting system, the Google podcast backend acts as an FTP site in the traditional podcast distribution model. Additionally, the Google podcast backend can assemble multiple audio files into a complex podcast and perform a speech-to-text conversion of the podcast. The text version of the podcast can then be published to the Internet so it will be visible in search engines (e.g., Google one-box search) and listeners can search for their desired podcasts to download.

Furthermore, the Google podcast backend can insert audio content dynamically when it receives a request for a podcast to be downloaded. In this manner, the Google podcast backend can dynamically select advertisements or other audio content to be delivered to the listener. The Google podcast backend can serve as an optional podcast solution for the broadcasters; however, when the broadcaster chooses to opt out of the Google podcast backend solution, audio content cannot be dynamically inserted into the podcast.

The general and specific aspects can be implemented using a system, method, or a computer program, or any combination of systems, methods, and computer programs. The details of one or more implementations are set forth in the accompanying drawings and the description below. Other features, aspects, and advantages will be apparent from the description, the drawings, and the claims.

### DESCRIPTION OF DRAWINGS

These and other aspects will now be described in detail with reference to the following drawings.

FIG. 1A is a conceptual diagram of a system that interfaces with the broadcaster and the Internet for podcasting generation and sourcing.

FIG. 1B illustrates various media asset manipulation tools for the audio toolbox.

FIG. 1C is a schematic diagram of the Google podcast backend used in the automated podcasting system.

FIG. 1D illustrates how a Google web plug-in for a broadcaster's website can interface with the Google podcast backend to deliver podcasts with targeted content to the listener.

FIG. 2 is a flow chart illustrating a process of delivering a podcast using the Google web plug-in in connection with the Google podcast backend.

FIG. 3A illustrates a graphical user interface (GUI) of the automated podcasting system that allows a user (e.g., a radio broadcaster) to configure global podcast settings.

FIG. 3B illustrates a GUI of the automated podcasting system that allows a user (e.g., a radio broadcaster) to configure a simple podcast.

FIG. 3C illustrates a GUI of the automated podcasting system that allows a user (e.g., a radio broadcaster) to define an episode of podcast.

FIG. 3D illustrates a GUI of the automated podcasting system that allows a user (e.g., a radio broadcaster) to configure a complex podcast.

FIG. 4 is a block diagram of computing devices and systems.

Like reference symbols in the various drawings indicate like elements.

### DETAILED DESCRIPTION

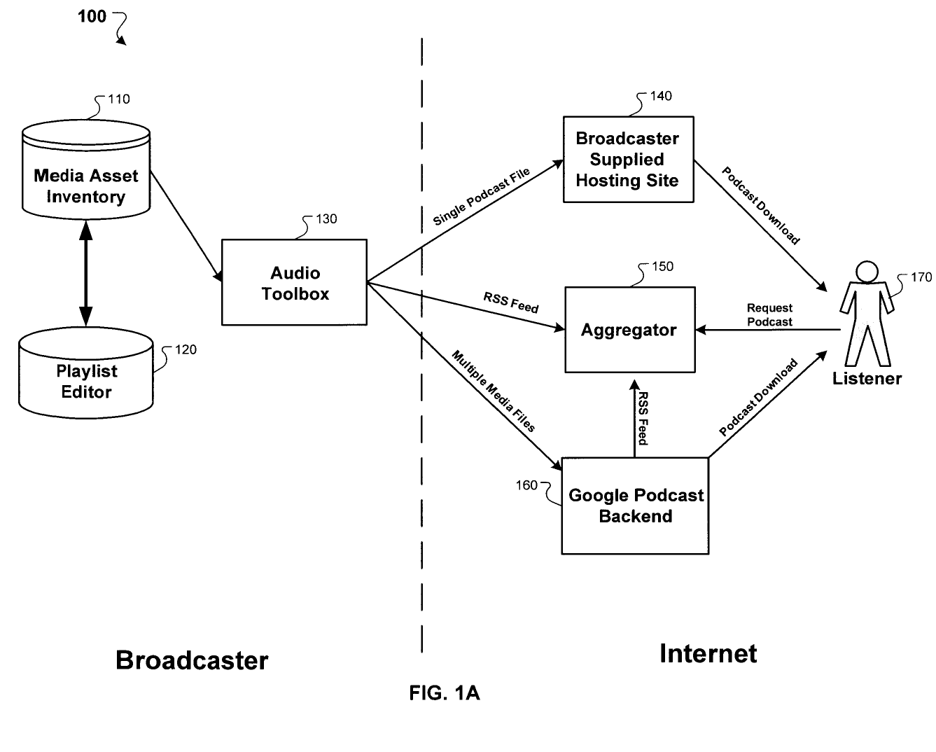

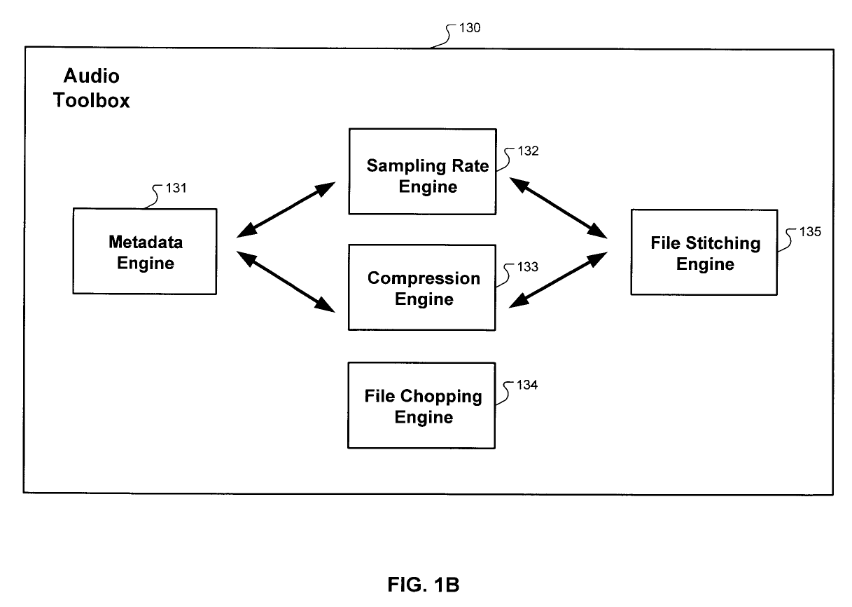

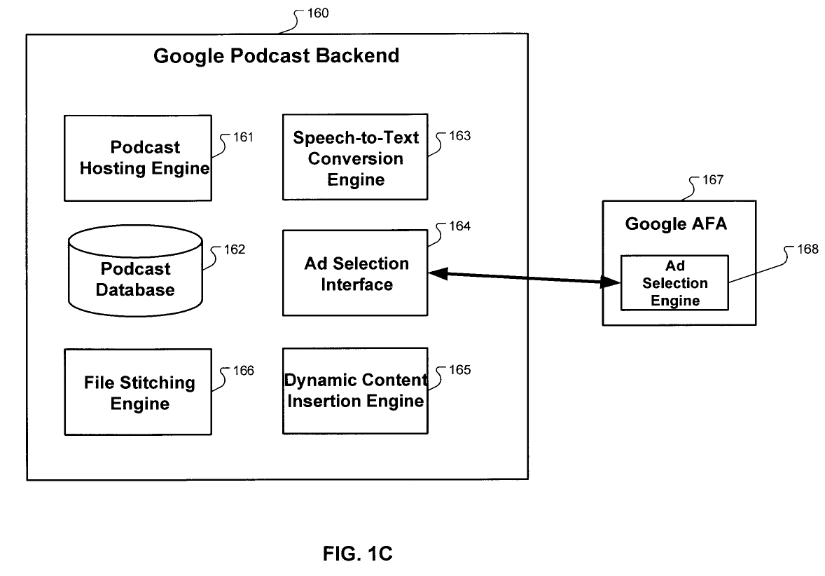

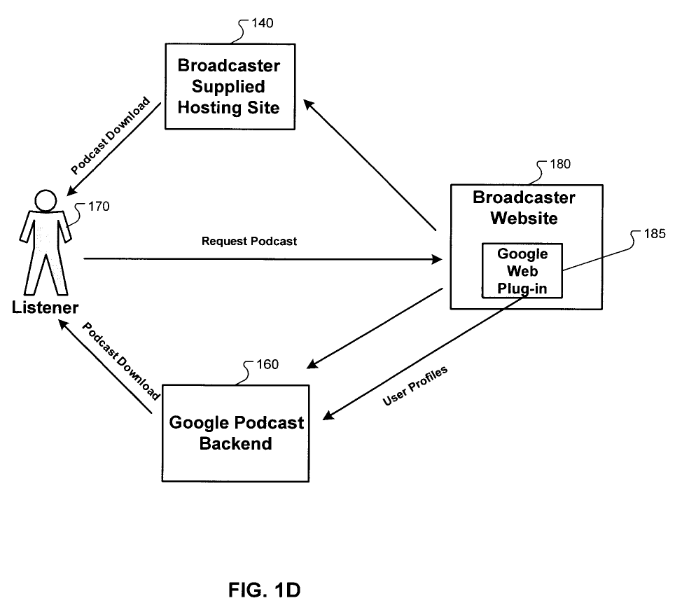

FIG. 1 is a conceptual diagram of a system 100 that interfaces with the broadcaster and the Internet for podcasting generation and sourcing. The system 100 has a media asset inventory 110, which can be a repository or a database used by the broadcaster to store any type of media asset. The term media asset is used herein broadly to include digital content, such as audio, video, or a combination of both. The media asset can be in the form of a Resource Interchange File Format (RIFF), a Waveform (WAV) audio format, an Interchange File Format (IFF), or any other file format that a broadcaster uses to digitize its broadcast content.

In one implementation, the system 100 can support two kinds of podcasts, simple and complex podcasts. A simple podcast contains one media asset from the media asset inventory 110. An example of a simple podcast is a newscast. A complex podcast contains multiple media assets from the media asset inventory 110. An example of a complex podcast is a music show, which can contain multiple songs and other audio content. The system 100 also has a playlist editor 120, which is communicatively coupled to the media asset inventory 110. The playlist editor 120 can allow the broadcaster to program certain types of media assets for broadcasting during a predetermined timeframe. As will be discussed in more detail below, the playlist editor 120 can also be used by the broadcaster to define podcasts.

Further, an audio toolbox 130 is communicatively coupled to the media asset inventory 110. The audio toolbox 130 can receive media assets from the media asset inventory 110 and allow the broadcaster to manipulate the received media assets for podcasting. These manipulations can include metadata conversion, sampling rate conversion, compression format conversion, and chopping and stitching of portions of media assets. Details of the audio toolbox 130 will be discussed further below.

Using the automated podcasting system 100, the broadcaster has a choice of podcast hosting options. In one implementation, the broadcaster may choose to host the podcasting on its own web server. In this case, the audio toolbox 130 can prepare the media assets desired for podcasting and transmit a podcast file to a broadcaster-supplied podcast hosting site 140, such as an FTP site. Additionally, the audio toolbox 130 can send a Really Simple Syndication (RSS) feed to a podcast aggregator 150, such as the iTunes software available through the Apple music store. RSS is the technology that enables listeners to search for and download relevant podcasts. Thus, as soon as the RSS feed of a new episode is uploaded to an aggregator, listeners can pull the podcast content from the hosting-site server automatically. The aggregator 150 can be a client software running on a portable device (e.g., an iPod) of a listener. Alternatively, the aggregator 150 can be a website that retrieves syndicated media content and displays updated search results of such content.

In another implementation, the broadcaster may choose to have Google or some other third party host the podcasting. In such case, the audio toolbox 130 can transfer multiple media files to the Google podcast backend 160, which manipulates the received media files into a podcast file. The Google podcast backend 160 can be a Google-hosted system that stores podcasts, performs speech-to-text conversion of podcasts, selects desired advertisements for inclusion in podcasts, and assembles podcasts for download. Details of how the Google podcast backend 160 works will be discussed further below. Once a podcast is ready for download, the Google podcast backend 160 can send an RSS feed to the aggregator 150.

Once the aggregator 150 receives the RSS feed for the podcast, a listener 170 can simply interface with the aggregator 150 to request the desired podcast for download. Alternatively, the listener 170 can download podcasts as individual audio files over a web browser or sometimes even peer-to-peer file transfer software. Additionally, the listener 170 can search submissions and entries in podcast directories, and download files individually, or play audio directly on a web browser as an embedded, streaming media. However, a popular way of receiving podcasts is through a subscription-based aggregator 150, using a pod-catcher or a podcast-client like iTunes or iPodder. Subscription may be through podcast directories or by manually entering a podcast's RSS feed URL onto the client. As noted above, podcasts may be listened to on a computer or on a portable media player, such as an iPod or an MP3 player.

When the listener 170 selects (e.g., by clicking) the desired podcast from a list of available podcast contents, the aggregator 150 can point to the corresponding podcast hosting site (i.e., a broadcaster-hosted site 140 or a Google-hosted site 160) that contains the podcast. In this manner, a transparent podcast hosting operation can be provided in that the listener 170 does not know (nor does she care) who is hosting the podcast site. As will be shown in more detail below, the Google-hosted podcasting option can offer more flexibility to the broadcaster in terms of dynamic content delivery, targeted ad insertion, and monetization of podcast content.

FIG. 1B illustrates various media asset manipulation tools for the audio toolbox 130. As indicated above, the audio toolbox 130 can include various functionality for manipulating media assets. In one implementation, the audio toolbox 130 includes a metadata conversion engine 131, which can perform the conversion of one metadata type to another type. Some of the exemplary metadata types can include title, artist, trivia, date of first broadcast, and the like. The metadata conversion engine 131 can interface with the sampling rate conversion engine 132 and the compression engine 133. In this manner, media assets that have different sampling rate or compression format can first be converted to the same sampling rate or compression format before the metadata conversion engine 131 converts them into the same metadata type. Thus, the automated podcasting system 100 can function seamlessly based on media assets that are created by other automated systems. Additionally, a user interface can be provided in the metadata conversion engine 131 to allow users to simply convert metadata types.

The audio toolbox 130 also includes a sampling rate conversion engine 132, which can convert the sampling rate for any audio files. The sampling rate is the frequency at which a broadcast audio can be converted into digitized media asset. For example, a typical sampling rate for a digitized audio is 44.1 kHz. The sampling rate conversion engine 132 can be used during import and export of media assets to and from the automated system 100. In one implementation, the sampling rate engine 132 can convert an audio file having a sampling rate between 8 kHz to 96 kHz, depending on the listener's audio fidelity requirement. Typically, a higher sampling rate can provide better sound quality; however, a larger file size is also required.

When a media asset is exported from the automated system 100, the broadcaster can have the option of specifying the sampling rate of the file created by the export process. In this manner, if the user-chosen sampling rate is different from the existing sampling rate of the media assets contained in the media asset inventory 110, the sampling rate conversion engine 132 can perform the conversion process during the export process. Therefore, the audio sampling rate of the media asset stored in the media asset inventory 110 is not changed, and the sampling rate conversion is only applied to the exported copy of the media asset.

Similarly, users can have the option of setting a default sampling rate for importing media assets into the automated system 100. Thus, any media asset that is imported into the automated system 100 can have the same default sampling rate. If the user wishes to import a media asset different from that of the default sampling rate, the sampling rate conversion engine 132 can convert that sampling rate of the imported media asset during the import process. Additionally, a user interface can be provided in the sampling rate conversion engine 132 and allow users to configure the default sampling rate for importing media assets.

The audio toolbox 130 further includes a compression engine 133, which can be used to convert media assets from one compression format to another. For example, the compression engine 133 can convert file types having an MP2 format to an MP3 format, a WMA format to a Linear compression format, or a Dolby AC2 compression format to an ACC format. When a media asset is exported from the automated system 100, the user can have the option of specifying the compression format of the media asset created by the export process. If the user-defined compression format for the exported media asset is not the same as the media asset's compression format in the media asset inventory 110, the compression engine 133 can achieve the desired compression format during the export process. Additionally, the compression format of the media asset stored in the media asset inventory 110 is not changed because the compression format is only changed on the exported copy of the media asset.

Similarly, users can have the option of setting a default compression format for importing media assets. For example, users can set the default compression format as the MP3 format. Thus, any media asset that is imported into the automated system 100 can have the same default MP3 compression format. If the user wishes to import a media asset that is not in MP3 compression format, the compression engine 133 can convert that compression format of the imported media asset into MP3 format during the import process. Additionally, a user interface can be provided in the compression engine 133 and allow users to configure the default compression format for importing media assets.

The audio toolbox 130 also includes a file chopping engine 134, which can extract portions of a media asset and provide a copy of the extracted portions. The file chopping engine 134 allows the users to select the desired portion of a media asset, and make a copy of that desire portion. Additionally the file chopping engine 134 can include functionality that enables it to interface and receive files of any sampling rate or compression format supported by the automated system 100. The file chopping engine 134 can also be used in distant city voice tracking. For example, the file chopping engine can be used to make a separate file comprising solely of the beginning and/or the end of a song. This file can then be used in an environment where a radio DJ makes pre-recorded announcements, and needs only the beginning and end of a song in order to record such announcements.

The audio toolbox 130 further includes a file stitching engine 135, which can combine two or more media assets into a single media asset. The file stitching engine 135 can interface with the sampling rate conversion engine 132 and the compression engine 133. In this manner, media assets that have different sampling rate and/or compression format can first be converted to the same sampling rate and/or compression format before the stitching engine 135 combines them into a single media asset.

FIG. 1C is a schematic diagram of the Google podcast backend 160. As indicated above, in one implementation, there are two steps involved in publishing a podcast. The first step is to create content (e.g., an audio file), and publish the content to a publicly available location, such as an FTP site. The second step is to create an RSS feed. The RSS feed contains details about the podcast, including the publicly available address (e.g., the Uniform Resource Locator (URL)) where the podcast can be downloaded. The RSS feed can then be transmitted to one or more aggregators (e.g. iTunes). When a listener requests to download the podcast, via the aggregator, the aggregator can redirect the listener's mobile device or computer to the publicly available site, and the podcast can be downloaded from that site. As discussed above, a user can also download an MP3 file in any other appropriate manner.

The Google podcast backend 160 includes a podcast hosting engine 161, which can act as the FTP site in the traditional podcast distribution model discussed above. In this manner, the Google podcast backend 160 can be a Google-hosted system that stores podcasts, performs speech-to-text conversion of podcasts, works with other Google components to select desired advertisements for inclusion in podcasts, and assembles podcasts for download. In one implementation, the Google podcast backend 160 also includes a podcast database 162, which can store various types of podcasts.

The podcasts that are stored in the podcast database 162 can either be received from the audio toolbox 130, or can be generated at the Google podcast backend 160. For example, if the podcast is generated at the Google podcast backend 160, it can be assembled from various media files received from the audio toolbox 130. The creation of content for podcasting can be done by the automation system. Depending on the type of content, the content may consist of one or more segments of audio, one or more markers indicating where commercials may be placed, as well as metadata tags describing the podcast. All of this information can go into a content ‘package’. Once the content package has been created, the automation system can publish it to the Google podcast backend 160.

The Google podcast backend 160 further includes a speech-to-text conversion engine 163, which can convert audio content into text strings. In one implementation, after the podcast content has been converted from audio to text, the Google podcast backend 160 can publish the text version of the podcast to the Internet so it will be visible in search engines (e.g., one-box search in the Google search engine) and listeners can search for their desired podcasts to be downloaded. Additionally, the text version of the podcast content can also be made available for immediate discovery using the Google web plug-in, which is a plug-in for the broadcaster's website and discussed in detail below.

Moreover, the Google podcast backend 160 includes an advertisement (“ad”) selection interface 164, which can interface with other Google components, such as the Google AFA (Adwords for Audio) 167, to select appropriate ads for the podcast. When the Google podcast backend 160 receives a request for a podcast to be downloaded, the ad selection interface 164 can receive selected ads from the ad selection engine 168 of Google AFA 167 to be inserted into the podcast. In this manner, the ad selection interface 164 and the AFA 167 can determine the most suitable ad using various amounts of information and metadata, which can vary depend on what tool the listener uses to download the podcast. As an example, a large number of listeners download podcasts via iTunes or similar software into their iPods.

The ad selection engine 168 of the AFA 167 can detect relevant information associated with the listener who is downloading the podcast and provide a customized ad content for delivery to the listener. Various criteria can be used by the ad selection engine 168 in selecting targeted ads for the podcast. For instance, the ad selection engine 168 can use the IP address of the device that is downloading the podcast and determine a geographical location associated with the device.

The ad selection engine 168 can also examine a history of podcasts previously served to the IP address. Additionally the ad selection engine 168 can use the date and time of podcast download in determining what targeted ads to insert in the podcast. Further, the ad selection engine 168 can use keywords specified in the podcast metadata or obtained from the text version of the podcast to select appropriate advertisements. Moreover, if a listener downloads a podcast via a Google web plug-in, additional demographic data associated with the listener can be obtained.

The Google podcast backend 160 additionally includes a dynamic content insertion engine 165, which can insert content on-the-fly as the podcast is downloaded to a listener. In one implementation, the dynamic content insertion engine 165 coordinates with the ad selection interface 164 to insert targeted ad content dynamically when a request for a podcast is received by the podcast hosting engine 161. In this manner, the dynamic content insertion engine 165 can dynamically insert advertisements or other audio content into the podcast to be delivered to the listener.

The Google podcast backend 160 further includes a file stitching engine 166, which can combine two or more media assets into a single media asset. In one implementation, the file stitching engine 166 can have similar functionality as the file stitching engine 135 of the audio toolbox 130. The file stitching engine 166 can interface with the dynamic content insertion engine 165 to combine different media portions into a single media asset for podcasting.

FIG. 1D illustrates how a Google web plug-in 185 for a broadcaster's website 180 can interface with the Google podcast backend 160 to deliver podcast with targeted content to the listener 170. The Google web plug-in 185 can be a component that a broadcaster incorporates into its website to allow the listener 170 to search for and subscribe to podcasts created by the broadcaster. For example, the listener 170 can access broadcaster's website 180 to request desired podcasts for download. Once the listener 170 is connected to the broadcaster's website 180, the Google web plug-in 185 can function as a user interface for the listener 170 to search for the inventory of podcasts on the broadcaster's website 180. In one implementation, the Google web plug-in 185 receives user profile information from the listener 170 and stores the user profile in the database.

When the listener 170 selects a desired podcast to download, the Google web plug-in 185 can direct the request to the Google podcast backend 164 for the actual download of the podcast. Additionally, the Google web plug-in 185 can provide user profile information of the listener 170 to the ad selection interface 164 of the Google podcast backend 160. In this manner, when the listener 170 downloads a podcast via the Google podcast web plug-in 185, the Google podcast backend 160 can have a greater amount of demographic data from the listener. This information can be used to better refine the ad selection process by the ad selection engine 168.

On the other hand, the broadcaster can have the option of not using the Google web plug-in 185 on the broadcaster's website 180. In such case, when the listener 170 requests a desired podcasts for download, the broadcaster's website 180 can direct the download request to the broadcaster-supplied hosting side 140. In contrast with the Google podcast backend 160, the broadcaster-supplied hosting site 140 does not have the functionality to provide added features such as targeted ads selection or dynamic content delivery for the podcast.

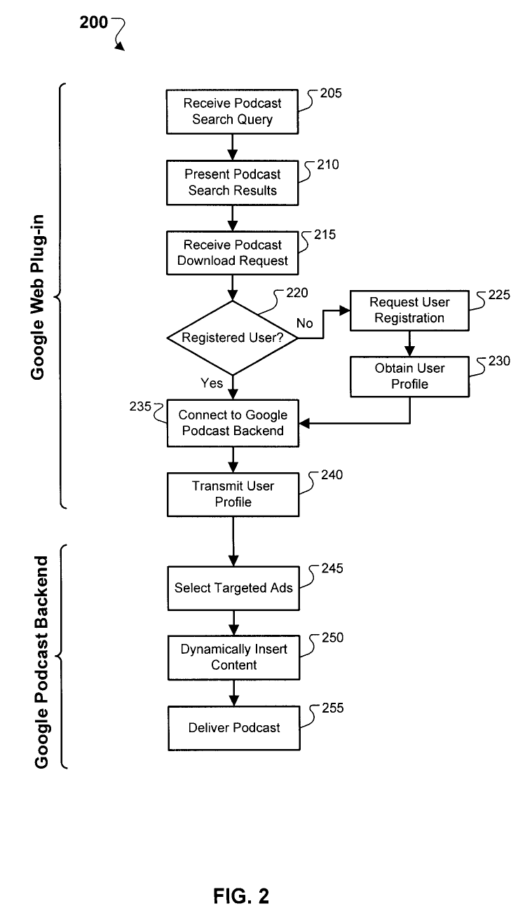

FIG. 2 is a flow chart illustrating a process 200 of delivering a podcast using the Google web plug-in 185 in connection with the Google podcast backend 160. As indicated above, the Google web plug-in 185 can be part of the broadcaster's website 180. Once the listener connects to the broadcaster's website, at 205, a podcast search query is received. This search query in submitted by the listener to find desirable podcasts to download. At 210, the podcast search result is presented to the listener based on the search query. At 215, process 200 receives a request for podcast download from the listener. At 220, process 200 determines if the listener is a registered user.

If the listener has not registered previously with the Google web plug-in 185, process 200 requests the user to register with the system, at 225. Additionally, at 230, user profile relating to the listener is obtained by the Google web plug-in. The user profile can include information such as the listener's address, age, programming preferences, educational level, employment information, and other personal information. In this manner, the personal information provided by the user and stored in the user profile can be used to better refine targeted content delivery to the user. However, due to privacy concerns, the user can have the option of opting out of this service.

On the other hand, if the listener is already a registered user and has not opted out, process 200 connects to the Google podcast backend at 235. Further, at 240, the user profile information is transmitted to the Google podcast backend. At the Google podcast backend, targeted ads is selected, at 245, based partially on the user profile information. At 250, process 200 dynamically inserts relevant content to the podcast. These relevant content can include targeted ads or program inserts for the podcast. At 255, the podcast is delivered to the listener's mobile player or computer.

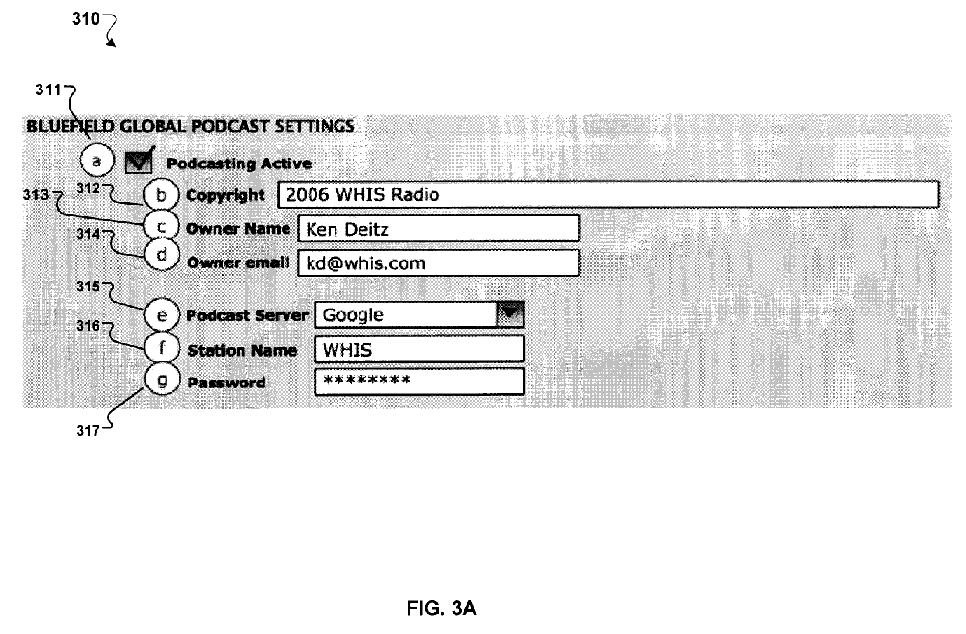

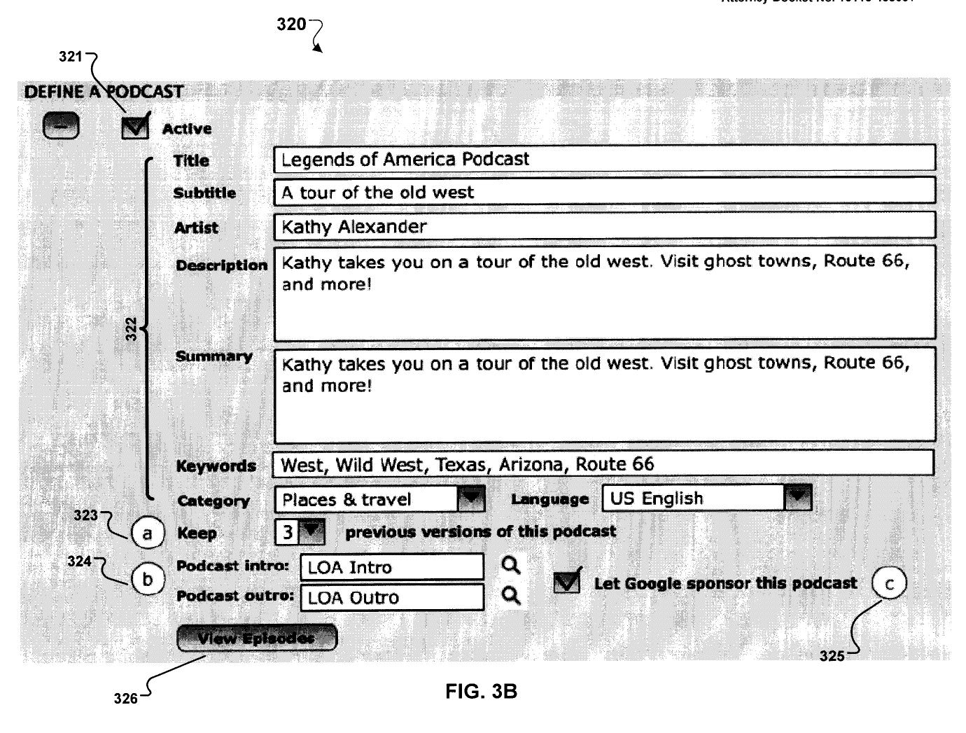

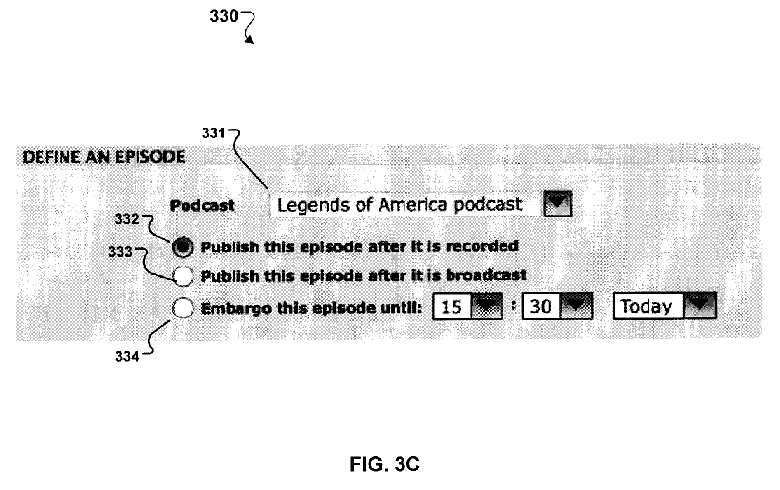

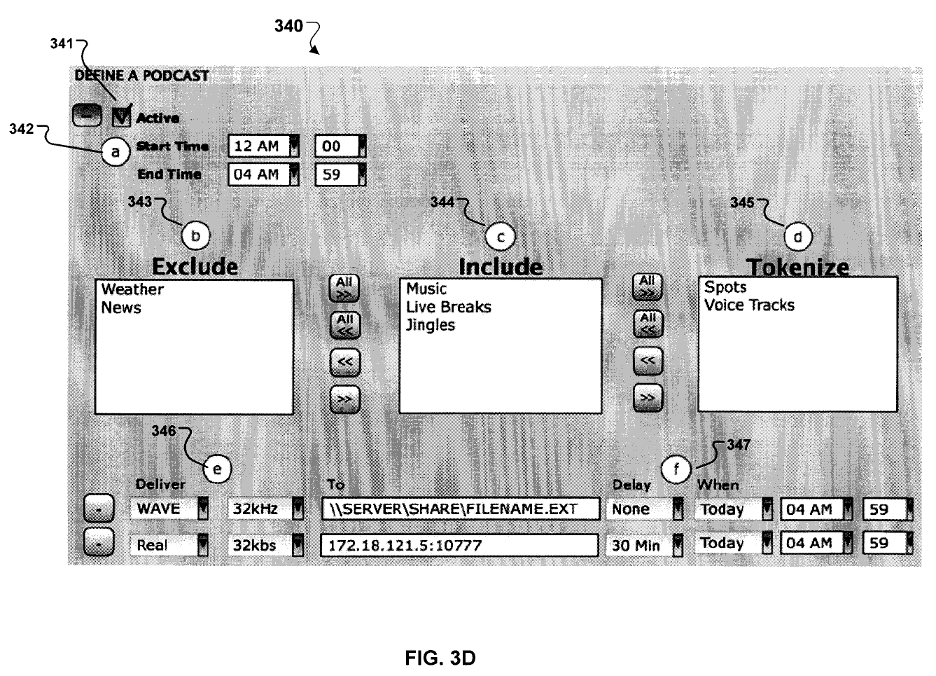

FIG. 3A illustrates a graphical user interface (GUI) 310 of the automated podcasting system that allows a broadcaster to configure global podcast settings. The global settings can be used to configure basic settings that apply to all podcasts generated by a particular broadcaster. GUI 310 can allow the user to enable podcasting for a particular radio broadcast simply by clicking on selection box 311 of GUI 310. In the example shown in field (a), the podcasting feature has been enabled by the user. GUI 310 also allows the user to enter copyright information for the podcast in text entry box 312. This copyright information can be transmitted as part of the RSS feed to the aggregator. In the example shown in field (b), the user has entered “2006 WHIS Radio” as the copyright owner of the podcast.

GUI 310 further allows the user to enter ownership and email contact information for the podcast in text entry box 313 and text entry box 314, respectively. Both the ownership and email information can also be transmitted as part of the RSS feed to the aggregator. In the example shown in fields (c) and (d), the user has entered “Ken Deitz” for the ownership information and “kd@whis.com” for the email information. Additionally, the drop-down menu 315 of GUI 310 allows the user to select the desired podcast hosting site, which can be a Google-hosted or a station-hosted site.

In the example shown in FIG. 3A, the user has selected Google as the podcast hosting site. Further, GUI 310 prompts the user to enter the station name in text entry box 316 and the password to the Google hosted site in text entry box 317. Once a user has successfully entered the station name and its corresponding password, the Google podcast backend can then grant the station the ability to upload podcasts to the Google podcast backend. In another implementation, the user may choose the option of hosting podcasts on its own server. In such cases, the user can select “Other” from the drop-down menu 315 of GUI 310. After doing this, new fields (not shown) can appear on the screen of GUI 310 to allow the user to enter relevant information for its server.

FIG. 3B illustrates a GUI 320 of the automated podcasting system that allows the user (e.g., a radio broadcaster) to configure a simple podcast. As noted above, a simple podcast is a podcast that contains only one media asset, such as a newscast. Configuration of a simple podcast can be done in a two-step process. The user first defines the podcast and then defines individual episodes of the broadcast which are to be converted to podcasts.

An operational overview of defining a simple podcast can be illustrated with the following example. Suppose that the radio station, KCMO, has a daily program called “Legends of America” hosted by Kathy Alexander. The program runs (e.g., airs) twice a day, at 8:20 AM and at 5:20 PM. The 5:20 PM show is not a rerun of the 8:20 AM show, so there are two unique shows daily. KCMO wishes to podcast “Legends of America.” Before the radio station may begin podcasting “Legends of America”, there is a one-time configuration to define the podcast, which can be done through the GUI 320 shown in FIG. 3B.

As shown in FIG. 3B, the station (KCMO) can define a simple podcast. Initially, the user can enable GUI 320 for defining a simple podcast by selecting the “Active” box 321. Then, the user can enter relevant information for the podcast through the podcast information entry 322, which contains various text entry boxes. For example, the user can enter information such as title, subtitle, artist's name, description, summary, keywords, category, and language information for the podcast. These podcast information can be used by the aggregator or the listener when searching for the appropriate podcasts to download. Additionally, as noted above, the keywords or category information can be used by the Google podcast backend (specifically, the ad selection engine as shown in FIG. 1C) in selecting targeted ads for dynamic insertion.

Besides entering the podcast information, GUI 320 allows the user to select the number of previous versions of the podcast to keep from the drop-down menu 323. In the example shown in field (a), KCMO has selected that the three latest episodes of “Legends of America” (“LOA”) are to be stored and kept available for download by listener 170. Additionally, GUI 320 allows the user to search for a particular media asset to be used as the introductory material (“podcast intro”) and concluding material (“podcast outro”) by clicking on the browser buttons 324 and selecting the desired media assets. In the example shown in field (b), KCMO has specified that the “LOA Intro” is to be applied to the beginning of the podcast and that the “LOA Outro” is to be applied to the end of the podcast.

Further, GUI 320 allows the user the option of selecting Google for sponsoring the podcast by clicking on the selection box 325. In the example shown in field (c), KCMO has elected for Google to sponsor the podcast. For example, using the Google podcast backend, the automation system can dynamically insert commercials in the podcast. Additionally, if Google sponsors a podcast, then the commercial can be inserted automatically between the intro and the content. Alternatively, if there is no intro for the podcast, the commercial can simply be added before the content.

GUI 320 also allows the user to get a preview of what content would be included in the podcast by clicking on the “view episodes” button 326. As noted above, the commercial or ads for the podcast can be inserted dynamically at download time when Google is sponsoring and hosting the podcast. Thus, the preview of podcast content can display which media assets are included in a given podcast.

Once the podcast has been defined by the broadcaster, episodes can be defined. In one implementation, the user can utilize a playlist editor (e.g., as shown in FIG. 1A) to define the episodes, if it wishes to podcast a program that is being broadcast on the radio station. In another implementation, the user can utilize a media asset manager, which is a UI for managing media assets (e.g., the media asset inventory 110, as shown in FIG. 1A) to define the episodes, if it wishes to podcast a program that is not broadcast on the radio station.

FIG. 3C illustrates a GUI 330 that allows a user to define an episode of podcast. In the above example, since KCMO broadcasts “Legends of America”, it can use the playlist editor to define an episode for the podcast. Inside the playlist editor, the user can open the “Podcast” drop down menu, and a list of all podcasts that have been defined (e.g., using GUI 320 of FIG. 3B) can be displayed. As an example, using the playlist editor, KCMO can find the 8:20 AM broadcast of “Legends of America” in the playlist. By right clicking on the desired broadcast, an option of “Create Podcast” can be selected from the drop-down menu. This allows the user to link the 8:20 AM broadcast to the Legends of America podcast. Additionally, once “Create Podcast” is selected, GUI 330 can be presented to the user.

As shown in FIG. 3C, GUI 330 has a drop down menu 331 that allows the user to select a particular podcast and define the episode for that podcast. Once the podcast is selected from menu 331, the user can then specify when to publish the podcast from one of the three choices in GUI 330. In one implementation, the user may specify that this episode of the podcast be published as soon as it is recorded by selecting box 332 in GUI 330. In this example, KCMO has elected to publish the 8:20 AM episode of “Legends of America” as a podcast as soon as it is recorded into the automated system.

In another implementation, the user may specify that this episode of the podcast be published as soon as it is broadcasted over the air by selecting box 333 in GUI 330. In this example, KCMO can elect to publish the 8:20 AM episode of “Legends of America” as a podcast as soon as it is broadcasted over the air after 8:20 AM. This option can be more popular because the broadcaster does not have to worry about losing the radio audience to the podcast audience.

In a further implementation, the user may place an embargo on this episode of the podcast and specify a predetermined time to publish the podcast by selecting box 334 in GUI 330 and defining the desired time. In this manner, GUI 330 allows the broadcaster an explicitly control of when the podcast is published. The process described above for defining a podcast episode can be repeated with additional podcast episodes (e.g., the 5:20 PM episode of “LOA”). The process described above for defining a podcast episode can be done only once; thus, new podcasts of both episodes of “Legends of America” can be created daily using a particular option specified by the user in GUI 330.

Alternatively, suppose that KCMO doesn't broadcast “Legends of America”, but it still wishes to offer the program as a podcast. In this case, KCMO can still define the “Legends of America” podcast using, for example, GUI 310. However, in such case, instead of using the playlist editor, KCMO would use media asset manager to create the podcast episodes. The media asset manager can have an option that allows the user to create a podcast from a selected media asset immediately. Additional fields (e.g., the same fields as shown in UI 330) can be added to the media asset manager. These fields can enable podcast-specific metadata to be added to the media asset when it is recorded, and that metadata can be included in the podcast.

FIG. 3D illustrates a GUI 340 of the automated podcasting system that allows the user (e.g., a radio broadcaster) to configure a complex podcast. As mentioned above, a complex podcast can contain more than one media asset from the media asset inventory. In order to build a complex podcast, the automated system waits until a certain time of day, and then collects all the items that are to be included in the podcast. The system then stitches (e.g., in the audio toolbox or Google podcast backend) all of the broadcast content into a single media file and publishes it as a podcast.

In one implementation, a complex podcast can be used when a radio station wishes to replicate a long, multi-segmented program that was broadcast by the radio station. The system can replicate the program by searching the playlist for the items that played during the program. The system can also have the ability to record live microphones (e.g., announcements and conversations) during the program, and incorporate that audio into the podcast. Therefore, it can be possible for live announced music programming to be captured and recreated as a complex podcast.

A user can configure a complex podcast using GUI 340. Initially, the user can enable GUI 340 for defining a complex podcast by selecting the “Active” box 341. GUI 340 also allows the user to define the start and end time for the podcast by selecting the desired time period in box 342. In this manner, all the media assets recorded during the specified time period can be used to assemble a complex podcast. Additionally, GUI 340 allows the user to define what categories of media assets to exclude, include, or tokenize in the complex podcast.

The “exclude” “include” and “tokenize” categories can be used by the automated system to assemble the complex podcast. For example, the user can specify a list of media asset categories to exclude by entering them in the “exclude” box 343. In the example shown in field (b), the user has excluded “weather” and “news” from being included in the complex podcast. The user can also specify a list of media asset categories to include by entering them in the “include” box 344. In the example shown in field (c), the user has specified that “music”, “live breaks”, and “jingles” categories be included in the complex podcast.

The user can further specify a list of media asset categories to be tokenized by entering them in the “tokenize” box 345. In the example shown in field (d), the user has specified that “sports” and “voice tracks” categories be tokenized for the complex podcast. In this manner, the user has the option of tokenizing certain categories of media asset by associating them with token flags. When a certain type of media asset has been associated with a token flag, it indicates that the tokenized media asset can be replaced with other media assets of similar type when the podcast is delivered to the listener (e.g., dynamically when the podcast is downloaded by the listener).

As an example, when the user specifies that the “commercial” category of the media asset be tokenized by setting a token flag with the “commercial” category, the automated system can replace the commercials that were broadcast on the air with different commercials at download time. This replacement of commercial content by the automated system can occur dynamically when the listener downloads the podcast. Additionally, the automated system can replace the tokenized commercial category with a combination of commercial having the same broadcast time duration. For example, suppose that the commercial that was broadcast over the air and tokenized was a 30-second commercial spot, the automated system can replace the 30-second spot with two 15-second commercial spots dynamically at download time.

Similarly, if the “voice tracks” category (e.g., live disc jockey (DJ) announcements or public service announcements) is tokenized by setting a token flag with the “voice tracks” category, voice tracks that were broadcast on the air can be replaced with different voice tracks that are intended specifically for podcasts. For example, suppose that the DJ announcement during the radio broadcast was “This program is brought to you by KABC 93.1 FM radio”, such announcement can be replaced dynamically at download time by a podcast-specific announcement, such as “This podcast is brought to you by KABC radio.”

Additionally, GUI 340 allows the user to define the encoding format and sampling rate for the podcast, as well as the publication path in the box 346. In the example shown in field (e), the user has defined the encoding format to be WAV format and the sampling rate to be 32 kHz. Additionally, the user has defined that a Real Player be used for web streaming (e.g., via Internet radio) at 32 kbps (kilobits per second) through the specified IP address. GUI 340 further allows the user to define when to publish the complex podcast by specifying the time in box 347.

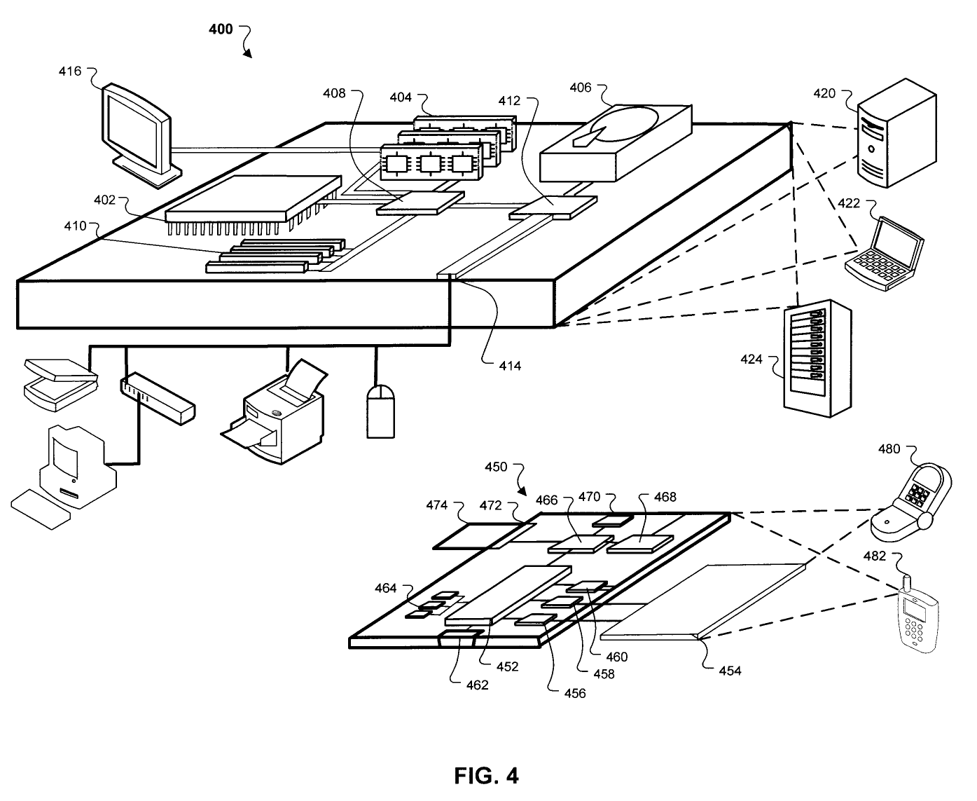

FIG. 4 is a block diagram of computing devices and systems 400, 450. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402,404, 406, 408, 410, and 412, are interconnected using various busses, and can be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses can be used, as appropriate, along with multiple memories and types of memory. Also, multiple computing devices 400 can be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 can be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, memory on processor 402, or a propagated signal.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which can accept various expansion cards (not shown). In the implementation, low-speed controller 412 is coupled to storage device 406 and low-speed expansion port 414. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 400 can be implemented in a number of different forms, as shown in the figure. For example, it can be implemented as a standard server 420, or multiple times in a group of such servers. It can also be implemented as part of a rack server system 424. In addition, it can be implemented in a personal computer such as a laptop computer 422. Alternatively, components from computing device 400 can be combined with other components in a mobile device (not shown), such as device 450. Each of such devices can contain one or more of computing device 400, 450, and an entire system can be made up of multiple computing devices 400, 450 communicating with each other.

Computing device 450 includes a processor 452, memory 464, an input/output device such as a display 454, a communication interface 466, and a transceiver 468, among other components. The device 450 can also be provided with a storage device, such as a microdrive or other device, to provide additional storage. Each of the components 450, 452, 464, 454, 466, and 468, are interconnected using various buses, and several of the components can be mounted on a common motherboard or in other manners as appropriate.

The processor 452 can process instructions for execution within the computing device 450, including instructions stored in the memory 464. The processor can also include separate analog and digital processors. The processor can provide, for example, for coordination of the other components of the device 450, such as control of user interfaces, applications run by device 450, and wireless communication by device 450.

Processor 452 can communicate with a user through control interface 458 and display interface 456 coupled to a display 454. The display 454 can be, for example, a TFT LCD display or an OLED display, or other appropriate display technology. The display interface 456 can comprise appropriate circuitry for driving the display 454 to present graphical and other information to a user. The control interface 458 can receive commands from a user and convert them for submission to the processor 452. In addition, an external interface 462 can be provide in communication with processor 452, so as to enable near area communication of device 450 with other devices. External interface 462 can provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 can also be provided and connected to device 450 through expansion interface 472, which can include, for example, a SIMM card interface. Such expansion memory 474 can provide extra storage space for device 450, or can also store applications or other information for device 450. Specifically, expansion memory 474 can include instructions to carry out or supplement the processes described above, and can include secure information also. Thus, for example, expansion memory 474 can be provide as a security module for device 450, and can be programmed with instructions that permit secure use of device 450. In addition, secure applications can be provided via the SIMM cards, along with additional information, such as placing identifying information on the SIMM card in a non-hackable manner.

The memory can include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal.

Device 450 can communicate wirelessly through communication interface 466, which can include digital signal processing circuitry where necessary. Communication interface 466 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 468. In addition, short-range communication can occur, such as using a Bluetooth, WiFi, or other such transceiver (not shown). In addition, GPS receiver module 470 can provide additional wireless data to device 450, which can be used as appropriate by applications running on device 450.

Device 450 can also communication audibly using audio codec 460, which can receive spoken information from a user and convert it to usable digital information. Audio codex 460 can likewise generate audible sound for a user, such as through a speaker, e.g., in a handset of device 450. Such sound can include sound from voice telephone calls, can include recorded sound (e.g., voice messages, music files, etc.) and can also include sound generated by applications operating on device 450.

The computing device 450 can be implemented in a number of different forms, as shown in the figure. For example, it can be implemented as a cellular telephone 480. It can also be implemented as part of a smartphone 482, personal digital assistant, or other similar mobile device.

Where appropriate, the systems and the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications can be made without departing from the spirit and scope of the described implementations. For example, the actions recited in the claims can be performed in a different order and still achieve desirable results. Accordingly, other implementations are within the scope of the following claims.

What is claimed is:

1. A computer-implemented method comprising:
receiving a request to download a podcast;
determining an item of audio content to be inserted into the podcast; and
inserting the item of audio content into the podcast dynamically at a predetermined time.

2. The method of claim 1, wherein the predetermined time is at podcast download time.

3. The method of claim 1, further comprising publishing the podcast at a hosting site.

4. The method of claim 3, wherein the hosting site is an FTP site maintained by a broadcaster.

5. The method of claim 3, wherein the hosting site is part of an automated podcasting system.

6. The method of claim 1, further comprising generating the podcast based on one or more broadcast audio files.

7. The method of claim 6, further comprising:
performing a speech to text conversion of the podcast; and
obtaining a text version of the podcast.

8. The method of claim 7, further comprising generating one or more keywords based on the text version of the podcast.

9. The method of claim 1, wherein the item of audio content is an advertisement.

10. The method of claim 1, wherein the item of audio content is a voice track.

11. The method of claim 10, wherein the voice track comprises a disc jockey announcement or a public service announcement.

12. The method of claim 3, further comprising:
sending a Really Simple Syndication (RSS) feed to a podcast aggregator.

13. The method of claim 8, further comprising obtaining the one or more broadcast audio files from a media asset inventory.

14. The method of claim 8, wherein generating the podcast comprises:
obtaining podcast information through a first graphical user interface (GUI); and
specifying a podcast publication time using a second GUI.

15. The method of claim 14, wherein the podcast information comprises one or more of the following items: title, subtitle, artist, description, summary, keyword, and category.

16. A computing device comprising a computer program product stored on a computer readable medium, the stored computer program product including executable instructions causing the computing device to perform functions comprising:
receiving a request to download a podcast;
determining an item of audio content to be inserted into the podcast; and
inserting the item of audio content into the podcast dynamically at a predetermined time.

17. The stored computer program product of claim 16, further including executable instructions causing the computing device to perform functions comprising publishing the podcast at a hosting site.

18. The stored computer program product of claim 16, further including executable instructions causing the computing device to perform functions comprising generating the podcast based on one or more broadcast audio files.

19. A system comprising:
a media asset inventory configured to store one or more broadcast audio files;
an audio toolbox configured to manipulate the one or more broadcast audio files stored in the media asset inventory;
a podcast hosting server; and
means for dynamically delivering a podcast.

20. The system of claim 19, further comprising:
a speech-to-text conversion engine configured to convert the one or more broadcast audio files into a text file.
